(19) United States
(12) Patent Application Publication
(10) Pub. No.: US 2011/0304360 A1
(43) Pub. Date: Dec. 15, 2011

(54) DIODE CIRCUIT

(76) Inventors: Naoyuki NAKAMURA, Kyoto (JP); Hiroyuki Miyachi, Kyoto (JP)

(21) Appl. No.: 13/158,961

(22) Filed: Jun. 13, 2011

(30) Foreign Application Priority Data
Jun. 15, 2010 (JP) 2010-136665

(51) Int. Cl. H02M 7/217

(52) U.S. Cl. 327/104

(57) ABSTRACT

The present invention introduces a diode circuit which achieves ideal diode characteristics which observe an enough reverse breakdown voltage, and whose forward voltage is nearly 0 V. An active diode has an anode terminal and a cathode terminal. The active diode includes a transistor which has a gate terminal, a drain terminal connected to one of the anode terminal and the cathode terminal, and a source terminal connected to the other one of the anode terminal or the cathode terminal; and a gate voltage generating circuit which delivers a gate voltage to the gate terminal, the gate voltage being adjusted to be equal to a threshold voltage of the transistor.

### BACKGROUND OF THE INVENTION

(1) Field of the Invention

The present invention relates to diode circuits and, in particular, to a diode circuit which achieves diode characteristics with a current conducted in one direction so as to block a current in the opposite direction, using a transistor.

(2) Description of the Related Art

To improve characteristics of diodes, either dedicated semiconductor devices or active diodes have been utilized. The active diodes are diode circuits which improve the diode characteristics using a circuit including an active device such as a transistor.

Among the dedicated semiconductor devices, well-known devices are the ones utilizing a pn-junction on a silicon substrate and the ones utilizing the Schottky barrier junction. With a use of the pn-junction, a dedicated semiconductor device is formed of p-type impurities and n-type impurities diffusing into the silicon substrate and contacting each other. With a use of the Schottky barrier junction, a dedicated semiconductor device is formed from the contact between a metal, such as platinum, and silicon.

A band gap structure, which is determined based on a material and a device structure, determines a diode forward voltage in physicality. Thus, at a small current of 1 A or smaller, the forward voltages of the pn-junction silicon diode and the Schottky barrier junction diode are approximately 0.6 V and 0.4 V, respectively.

When the forward voltage is to be changed, the device structure, such as a material and a dopant concentration, is changed. Unfortunately, the forward voltage could be changed by not more than 0.1 V. Accordingly, it is impossible to set the forward voltage to near 0 V in order to achieve ideal diode characteristics, no matter how the diffusing process, the device structure, and the size of the device are optimized.

Hence, some diode circuits use transistors to achieve the ideal diode characteristics. The diode circuits are referred to as active diodes. Other diode circuits, using Metal Oxide Semiconductor Field Effect Transistors (MOSFET) diode circuits, are referred to as MOS diodes.

FIG. 5 shows a structure of a conventional MOS diode. According to FIG. 5, the conventional MOS diode includes a P-type MOSFET (hereinafter referred to as a PchMOSFET) whose gate terminal 503 and drain terminal 502 are connected each other, and whose back gate terminal 504 is connected to a power-supply voltage 505.

FIG. 6 is a circuit diagram showing an equivalent circuit of FIG. 5 or a typical diode device. A source terminal 501 and a drain terminal 502 in FIG. 5 respectively correspond to an anode 601 and cathode 602 in FIG. 6.

Described hereinafter are operations of the active diode shown in FIG. 5.

Most of conventional MOS diodes, one of which is exemplified in FIG. 5, include MOSFETs. This is because such a MOS diode has MOSFETs integrated, and the neighboring transistors isolated. Thus a part, referred to as a body or a well which is connected at the same potential as that observed on the back gate terminal 504, is connected to the lowest potential or the highest potential. Since the transistor exemplified in FIG. 5 is a PchMOSFET, the part is connected to the power-supply voltage 505; namely, the highest potential.

The transistor in FIG. 5 is beneficial in reducing the MOS diode in size. On the other hand, as current voltage characteristics 702 of the conventional MOS diode shows in FIG. 7, the forward voltage of the diode characteristics nearly coincides with a threshold voltage of the PchMOSFET; that is, approximately 0.7 V.

Patent Reference 1 (Japanese Unexamined Patent Application Publication No. 2001-230425) discloses a diode circuit which reduces the forward voltage of the diode characteristics.

FIG. 8 shows a structure of an active diode which achieves ideal diode characteristics using a conventional PchMOSFET described in Patent Reference 1. According to FIG. 8, a gate terminal 803, a drain terminal 802, and a back gate terminal 804 of the PchMOSFET are connected each other. A source terminal 801 And the drain terminal 802 in FIG. 8 respectively correspond to the anode 601 and the cathode 602 in FIG. 6.

In order to improve the forward voltage, Patent Reference 1 has proposed to have the body or the well of the PchMOSFET work as a single element region and the back gate terminal 804 connected to the drain terminal 802 as shown in FIG. 8. Accordingly, the threshold voltage of the PchMOSFET reduces.

As a result, as shown by current voltage characteristics 701 of an improved MOS diode, the forward voltage of the diode characteristics nearly coincides with the reduced threshold voltage of the PchMOSFET. This makes the active diode closer to that having more ideal diode characteristics. For example, the forward voltage can be decreased to as low as 0.3 V.

Patent Reference 2 (Japanese Unexamined Patent Application Publication (Translation of PCT application) No. 2002-511692) discloses another diode circuit which further reduces the forward voltage of the diode characteristic.

FIG. 9 shows a structure of an active diode which achieves ideal diode characteristics using a conventional N-type MOSFET (hereinafter referred to as NchMOSFET) described in Patent Reference 2. In FIG. 9, the active diode is structured as follows: A source terminal of a transistor (three-terminal switching unit) 900, a positive input terminal 903 of a voltage comparator 902, and an anode terminal A are connected each other; a drain terminal of the transistor 900, a negative input terminal 904 of the voltage comparator 902, and a cathode terminal K are connected each other; and an output terminal 905 of the voltage comparator 902, and a gate terminal of the transistor 900 are connected each other. The transistor 900 is an NchMOSFET, and has a fixed diode 901 between the source terminal and the drain terminal.

Described hereinafter are operations of the active diode shown in FIG. 9.

The voltage comparator 902 compares a voltage at the anode terminal A with a voltage at the cathode terminal K. When the voltage at the anode terminal A is greater, the gate signal of the transistor 900 goes high, and the transistor 900 is turned on. Here the forward voltage of the diode characteristics is decreased to as low as 0 V, which contributes to achieving the nearly ideal diode characteristics.

### SUMMARY OF THE INVENTION

These conventional techniques have problems below.

In the diode circuit described in Patent Reference 1, the forward voltage is controlled through the diffusion process for setting dopant concentration and diffusion depth. Thus it is highly difficult to set the dopant concentration and diffusion depth to any given designed value.

The diode circuit described in Patent Reference 2 has the voltage comparator 902 provided between the anode terminal A and the cathode terminal K. According to this structure, the breakdown voltage of the voltage comparator 902 affects that of the diode circuit. Since an input breakdown voltage of the voltage comparator 902 is not greater than 40 V, the breakdown voltage of the diode circuit is also 40 V. Thus the diode circuit cannot be used for rectifying a lighting circuit voltage ranging between 100 V and 240 V or a high-power-with-a-high-voltage apparatus whose secondary-side voltage at an isolation transformer is 40 V or greater.

The present invention is conceived in view of the above problems and has an object to introduce a diode circuit which achieves ideal diode characteristics which observe an enough reverse breakdown voltage, and whose forward voltage is nearly 0 V.

In order to solve the above problems, a diode circuit according to an aspect of the present invention has an anode terminal and a cathode terminal. The diode circuit includes a first transistor which has a gate terminal, a drain terminal connected to one of the anode terminal and the cathode terminal, and a source terminal connected to the other one of the anode terminal or the cathode terminal; and a gate voltage generating circuit which (i) is not connected to the cathode terminal but is provided between the gate terminal and the anode terminal, and (ii) delivers a gate voltage to the gate terminal, the gate voltage being adjusted to be equal to a threshold voltage of the first transistor.

This structure allows a gate voltage, adjusted to be equal to a threshold voltage of the first transistor, to be delivered to the gate terminal. This contributes to bringing the forward voltage to near 0 V. Furthermore, the gate voltage generating circuit is not connected to the cathode terminal, and thus does not affect the reverse breakdown voltage of the diode circuit. Hence the breakdown voltage of the diode circuit is determined by that of the first transistor, which contributes to achieving an excellent reverse breakdown voltage.

The diode circuit may include a second transistor which has a gate terminal, a drain terminal, and a source terminal, the gate terminals of the first transistor and the second transistor being connected each other, either the drain terminals or the source terminals of the first transistor and the second transistor being connected to the anode terminal, and either the drain terminals or the source terminals connected to the anode terminal being connected each other, wherein the gate voltage generating circuit may include: a reference voltage source which generates a reference voltage; a resistor across which a voltage develops, the voltage being for a drain current that runs into the second transistor; and an operational amplifier which has a positive input terminal that receives the reference voltage, a negative input terminal that receives the voltage generated across the resistor, and an output terminal that is connected to the gate terminals of the first transistor and the second transistor, and the second transistor may be a part of a negative feedback loop of the operational amplifier.

According to this structure, the first and the second transistors may have their gate terminals connected each other and their source terminals (or their drain terminals) connected each other. This structure also allows the operational amplifier to form a negative feedback loop, so that the drain current of the second transistor makes the reference voltage and the leak current setting value equal. Hence the gate voltage generating circuit can correctly generate a gate voltage near a threshold voltage, which contributes to bringing the forward voltage to near 0 V.

The present invention can achieve ideal diode characteristics which observe an enough reverse breakdown voltage, and whose forward voltage is nearly 0 V.

### FURTHER INFORMATION ABOUT TECHNICAL BACKGROUND TO THIS APPLICATION

The disclosure of Japanese Patent Application No. 2010-136665 filed on Jun. 15, 2010 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 exemplifies a structure of a diode circuit according to Embodiment 1 of the present invention;

FIG. 2 shows current-voltage characteristics of the diode circuit according to Embodiment 1 of the present invention;

FIG. 3 exemplifies a structure of a diode circuit according to Embodiment 2 of the present invention;

FIG. 4 shows current-voltage characteristics of the diode circuit according to Embodiment 2 of the present invention;

FIG. 5 is a circuit diagram of a MOS diode which uses a conventional PchMOSFET;

FIG. 6 is a circuit diagram showing an equivalent circuit included in the MOS diode or a typical diode device;

FIG. 7 shows current-voltage characteristics of the MOS diode;

FIG. 8 shows a diode circuit including a PchMOSFET of Patent Reference 1; and

FIG. 9 shows a diode circuit including an NchMOSFET of Patent Reference 2.

### DESCRIPTION OF THE PREFERRED EMBODIMENTS

Described hereinafter are diode circuits according to

Embodiments of the present invention with reference to the drawings.

### Embodiment 1

A diode circuit (an active diode) according to Embodiment 1 of the present invention includes the following: a transistor which has (i) a gate terminal, (ii) a drain terminal connected to one of an anode terminal and a cathode terminal, and (iii) a source terminal connected to the other one of the anode terminal and the cathode terminal; and a gate voltage generating circuit which delivers a gate voltage to the gate terminal. Here the gate voltage is adjusted to be equal to a threshold voltage of the transistor. The gate voltage generating circuit is not connected to the cathode terminal but is provided between the anode terminal and the gate terminal.

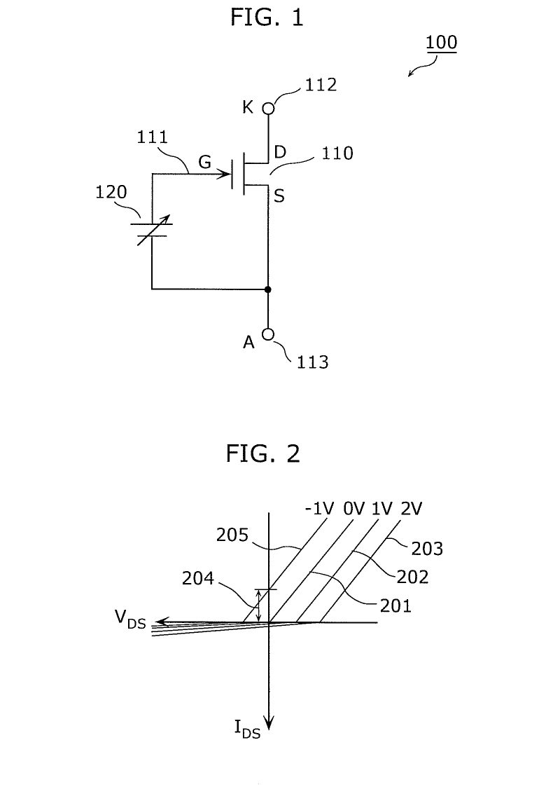

FIG. 1 exemplifies a diode circuit (an active diode 100) according to Embodiment 1 of the present invention. The active diode 100 has an anode terminal A and a cathode terminal K. When a forward voltage is applied between the anode terminal A and the cathode terminal K, a current runs from the anode terminal A to the cathode terminal K in the active diode 100. Here, in the forward voltage, the potential of the cathode terminal K is lower than that of the anode terminal A.

When a reverse voltage is applied between the anode terminal A and the cathode terminal K, very little current runs in the active diode 100. Here, in the reverse voltage, the potential of the cathode terminal K is higher than that of the anode terminal A. It is noted that specific current-voltage characteristics of the active diode 100 shall be described later.

As shown in FIG. 1, the active diode 100 includes a transistor 110, and a gate voltage generating circuit 120 which delivers a gate voltage adjusted to be equal to the threshold voltage.

The transistor 110 is an example of a first transistor, and may be a gallium nitride gate injection transistor (hereinafter referred to as a GaN-GIT). The transistor 110 includes a gate terminal 111 A drain terminal 112, and a source terminal 113.

As shown in FIG. 1, the gate terminal 111 is connected to the gate voltage generating circuit 120. The drain terminal 112 is connected to the cathode terminal K. The source terminal 113 is connected to the anode terminal A. The source terminal 113 is connected to the gate voltage generating circuit 120 which delivers a gate voltage adjusted to be equal to the threshold voltage. It is noted that the transistor 110 may be either the PchMOSFET or the NchMOSFET. When the transistor 110 is a PchMOSFET to sustain a high breakdown voltage, for example, the drain terminal 112 and the source terminal 113 of the PchMOSFET are respectively connected to the anode terminal A and the cathode terminal K. When the transistor 110 is an NchMOSFET to sustain a high breakdown voltage, the drain terminal 112 and the source terminal 113 of the NchMOSFET are respectively connected to the cathode terminal K and the anode terminal A.

The gate voltage generating circuit 120 delivers to the gate terminal 111 the gate voltage adjusted to be equal to the threshold voltage of the transistor 110. Specifically, the gate voltage generating circuit 120 uses the source terminal 113 of the transistor 110 as a reference to deliver a voltage to the gate terminal 111 of the transistor 110. In other words, the gate voltage generating circuit 120 delivers a gate-to-source voltage.

The gate voltage generating circuit 120 is a voltage generator whose gate voltage is adjusted to be equal to a threshold voltage of the transistor 110. In FIG. 1, the gate voltage generating circuit 120 uses a direct-current (DC) amplifier to vary a reference voltage by constant multiplication, so that the generated voltage via the variation is equal to the previously measured threshold voltage of the transistor 110. For example, the gate voltage generating circuit 120 may have (i) a DC amplifier connect to a reference voltage source in series, and (ii) a negative feedback loop of the DC amplifier connect either to a trimmer resistor or a variable resistor.

In the above structure, the active diode 100 according to Embodiment 1 of the present invention delivers to the gate terminal the gate voltage adjusted to be equal to the threshold voltage of the transistor 110, which contributes to bringing the forward voltage of the active diode 100 to near 0 V. Since no other device is provided between the anode terminal A and the cathode terminal K, the breakdown voltage of the active diode 100 is determined by the breakdown voltage of the transistor 110. The breakdown voltage of the transistor 110 is usually 40 V or higher. Accordingly, the active diode 100 can achieve an excellent reverse breakdown voltage.

Described next are the current-voltage characteristics of the active diode 100 according to Embodiment 1 of the present invention. FIG. 2 exemplifies current-voltage characteristics of the active diode 100 shown in FIG. 1.

A threshold voltage of a typical Gan-GIT, such as the transistor 110, is 2 V, for example. Current-voltage characteristics 201 are observed when (i) a reference voltage, adjusted by the gate voltage generating circuit 120 to be almost equal to the threshold voltage of the transistor 110, is delivered to the gate terminal 111 and (ii) the forward voltage is 0 V. Current-voltage characteristics 202 are observed when (i) a reference voltage, adjusted to some extent by the gate voltage generating circuit 120, is delivered to the gate terminal 111 and (ii) the forward voltage is 1 V. Current-voltage characteristics 203 are observed when (i) the gate voltage generating circuit 120 generates no voltage; namely 0 V, and (ii) the forward voltage is 2 V.

Described hereinafter are the operations of the active diode 100 as structured above. It is noted that the description exemplifies the case where the threshold voltage of the transistor 110 is 2 V.

When a gate voltage generated by the gate voltage generating circuit 120 is 2 V, the current-voltage characteristics of the active diode 100 are the current-voltage characteristics 201 whose forward voltage is 0 V. This makes the current-voltage characteristics of the diode ideal. However, for example, the threshold voltage of the GaN-GIT varies from 1 V to −1 V.

When the threshold voltage of the transistor 110 is 1 V and the gate voltage generated by the gate voltage generating circuit 120 is 2 V, for example, the current-voltage characteristics of the active diode 100 are the current-voltage characteristics 205 whose forward voltage is −1 V as shown in FIG. 2. Such characteristics develop a reverse current (a leak current 204) in a rectifying operation, and are not close to the ideal ones.

When the threshold voltage of the transistor 110 is 3V and the voltage generated by the gate voltage generating circuit 120 is 2 V, for example, the current-voltage characteristics of the active diode 100 are the current-voltage characteristics 202 whose forward voltage is 1 V as shown in FIG. 2. This makes a loss observed at the active diode 100 greater than that observed at a silicon pn-junction diode.

Hence, in order to make the diode characteristics ideal, the gate voltage generating circuit 120 needs to precisely associate the gate voltage delivered to the gate terminal 111 of the transistor 110 with the threshold voltage of the transistor 110. Specifically, the gate voltage generating circuit 120 uses an adjusting unit, such as the DC amplifier, to vary a reference voltage by constant multiplication so that the reference voltage is adjusted to be equal to the threshold voltage of the transistor 110. Through the adjustment, the gate voltage generating circuit 120 generates a gate voltage which is equal to the threshold voltage of the transistor 110.

Hence, in the active diode 100 according to Embodiment 1 of the present invention, the gate voltage generating circuit 120 delivers the gate voltage, which has been adjusted to be equal to the threshold voltage of the transistor 110, to the gate terminal 111 of the transistor 110. This operation makes possible bringing the forward voltage of the active diode 100 to almost 0 V, which contributes to achieving excellent diode characteristics.

In the active diode 100 according to Embodiment 1 of the present invention, the gate voltage generating circuit 120 does not observe a drain voltage of the transistor 110. Thus, in a high voltage region of 40 V or higher, the active diode 100 does not suffer from a low breakdown voltage in a control circuit (the gate voltage generating circuit 120), which contributes to achieving an excellent reverse breakdown voltage.

### Embodiment 2

A diode circuit (an active diode) according to Embodiment 2 of the present invention includes the following: A second transistor having a gate terminal and a source terminal respectively connected to the gate terminal and the source terminal of the first transistor, the source terminals which are connected to an anode terminal; and a gate voltage generating circuit which delivers a gate voltage to the gate terminal of the first transistor and to the gate terminal of the second transistor, the gate voltage which is adjusted to be equal to a threshold voltage of the first transistor. The gate voltage generating circuit includes the following: A reference voltage source which generates a reference voltage; a resistor which generates a voltage for a drain current that runs into the second transistor; and an operational amplifier which has a positive input terminal that receives the reference voltage, a negative input terminal that receives the voltage generated by the resistor, and an output terminal that is connected to the gate terminals.

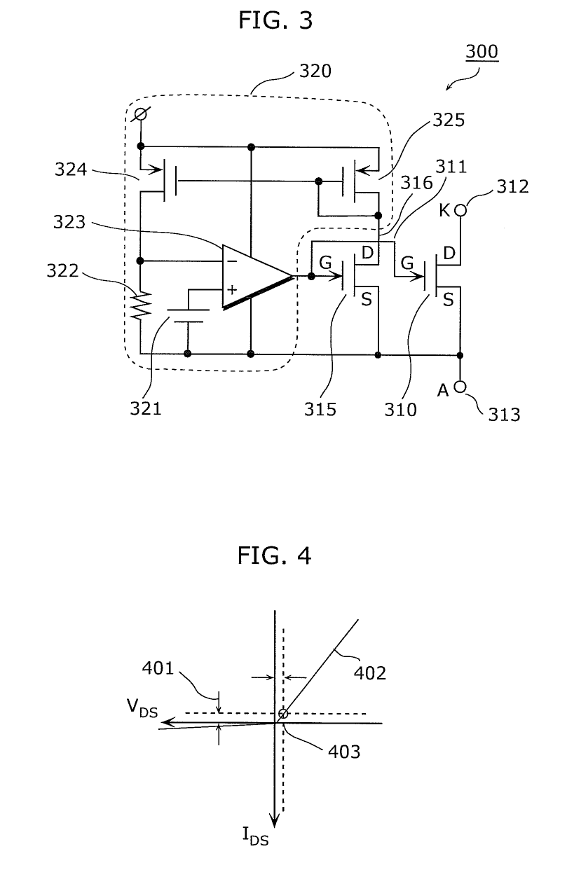

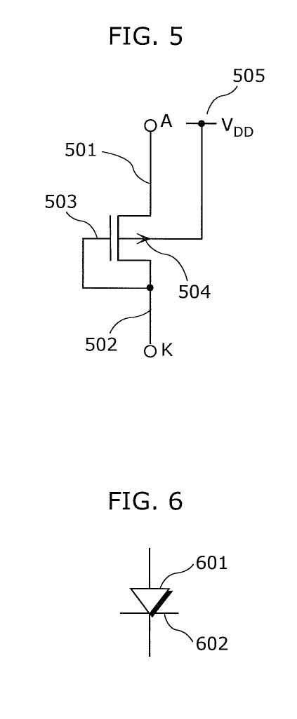

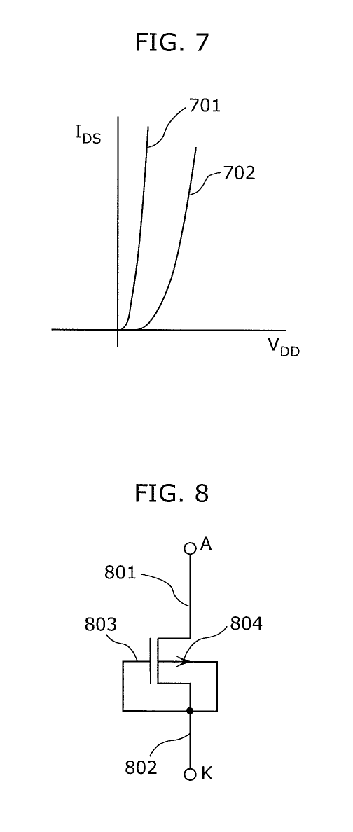

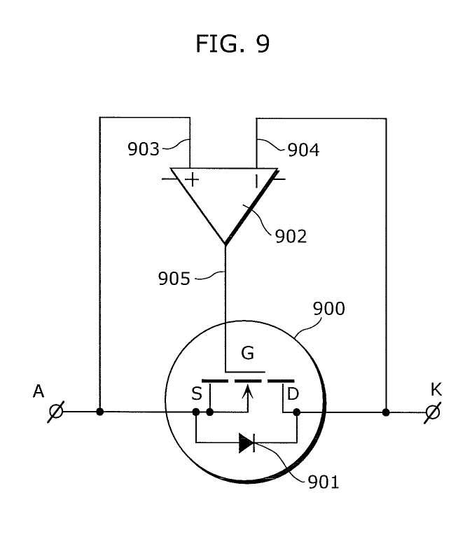

FIG. 3 exemplifies a structure of a diode circuit (an active diode 300) according to Embodiment 2 of the present invention. The active diode 300 has an anode terminal A and a cathode terminal K.

As shown in FIG. 3, the active diode 300 includes a first transistor 310, a second transistor 315, and a gate voltage generating circuit 320.

The first transistor 310 is a Gan-GIT, for example. The first transistor 310 has a gate terminal 311, a drain terminal 312, and a source terminal 313.

The gate terminal 311 is common to the gate terminal of the second transistor 315, and connects to the gate voltage generating circuit 320. The drain terminal 312 is connected to the cathode terminal K. The source terminal 313 works as a source terminal of the second transistor 315, and connects to the anode terminal A. In other words, the gate terminal and the source terminal of the first transistor 310 are respectively connected to the gate terminal and the source terminal of the second transistor 315. Here the source terminals are connected to the anode terminal A.

The second transistor 315 is a Gan-GIT, for example. The second transistor 315 has another gate terminal 311, the drain terminal 316, and the source terminal 313. The drain terminal 316 is connected to the gate voltage generating circuit 320. The second transistor 315 is a part of a negative feedback loop of an operational amplifier 323 included in the gate voltage generating circuit 320.

It is noted that the first transistor 310 and the second transistor 315 may be either PchMOSFETs or NchMOSFETs.

The gate voltage generating circuit 320 delivers a gate voltage to the gate terminals 311. Here the gate voltage is adjusted to be equal to a threshold voltage of the first transistor 310. As shown in FIG. 3, the gate voltage generating circuit 320 includes a reference voltage source 321, a resistor 322 for setting a target leak current, the operational amplifier 323, and PchMOSFETs 324 and 325.

The reference voltage source 321 generates a reference voltage, and connects to a positive input terminal (+) of the operational amplifier 323.

The resistor 322 for setting a target leak current sets a leak current. One end of the resistor 322 for setting a target leak current is connected to a negative input terminal (−) of the operational amplifier 323. The other end of the resistor 322 for setting a target leak current is connected to the reference voltage source 321 and to the source terminal 313.

The operational amplifier 323 amplifies the difference between voltages delivered to the positive input terminal (+) and the negative input terminal (−), and provides the amplified voltage from the output terminal. The output terminal of the operational amplifier 323 is connected to the gate terminals 311 for the first and second transistors 310 and 315.

The PchMOSFETs 324 and 325 form what commonly called a mirror circuit. The gate terminal and the source terminal of the PchMOSFET 324 are respectively connected to the gate terminal and the source terminal of the PchMOSFET 325. The drain terminal of the PchMOSFET 324 is connected to the one end of the resistor 322 for setting a target leak current, and to the negative input terminal of the operational amplifier 323. The drain terminal of the PchMOSFET 325 is connected to the gate terminal of the PchMOSFET 325 and to the drain terminal 316 of the second transistor 315.

Described hereinafter are operations of the active diode 300.

The gate voltage generating circuit 320 and the second transistor 315 form the negative feedback loop.

The difference between the input voltages provided to the operational amplifier 323 (=the positive input voltage−the negative input voltage) is amplified and provided from the output terminal of the operational amplifier 323 to the gate terminal of the second transistor 315. The second transistor 315 inverts and amplifies the signal provided to the gate terminal, and sends the signal from the drain terminal 316 as a drain current.

The drain terminal 316 of the second transistor 315 is connected to the drain terminal and the gate terminal of the PchMOSFET 325. The PchMOSFETs 324 and 325 form what commonly called a mirror circuit. Thus the current provided from the second transistor 315 to the drain terminal of the PchMOSFET 325 is copied to the drain terminal of the PchMOSFET 324. Hence a current of mirror-ratio-times the provided current runs.

Flowing from the drain terminal of the PchMOSFET 324, the drain current runs to the resistor 322 for setting a target leak current, and generates at the one end a voltage proportional to the drain current of the second transistor 315.

The operational amplifier 323 compares the generated voltage proportional to the leak current with the reference voltage generated by the reference voltage source 321 and executes a negative feedback operation. As a result, the active diode 300 is free from absolute variations between the first transistor 310 and the second transistor 315, and a change in temperature characteristics. Thus the active diode 300 can correctly generate a gate voltage near the threshold value of the first transistor 310. Hence the active diode 300 according to Embodiment 2 of the present invention can achieve the forward voltage of 0 V, which makes the diode characteristics ideal.

Described hereinafter are the characteristics of the active diode 300.

FIG. 4 exemplifies current-voltage characteristics of the active diode 300 according to Embodiment 2 of the present invention. FIG. 4 shows a leak current 401, current-voltage characteristics 402 whose forward voltage is 0 V, and a reference voltage 403.

The operational amplifier 323 included in the gate voltage generating circuit 320 operates so that the current-voltage characteristics of the active diode 300 according to Embodiment 2 of the present invention pass through the point of intersection between the reference voltage 403 and the leak current 401. When the reference voltage 403 and the leak current 401 are set near 0 V and 0 mA; namely the origin, the value of the output voltage of the operational amplifier 323 included in the gate voltage generating circuit 320 goes close to the threshold voltage of the first transistor 310. This contributes to achieving the current-voltage characteristics whose forward voltage is 0 V.

Thanks to the gate voltage generating circuit 320, the active diode 300 according to the Embodiment 2 of the present invention can achieve a forward voltage of nearly 0 V, which contributes to a significant reduction of diode loss. Specifically, in the active diode 300, the negative feedback loop of the operational amplifier 323 is formed so that (i) the gate terminal and the source terminal of the first transistor 310 respectively connect to the gate terminal and the source terminal of the second transistor 315, and (ii) the drain current of the second transistor 315 makes the reference voltage and the leak current setting value equal. Hence the gate voltage generating circuit 320 can accurately generate a gate voltage near the threshold voltage, which contributes to bringing the forward voltage of the active diode 100 to near 0 V.

In the active diode 300 according to Embodiment 2 of the present invention, the gate voltage generating circuit 320 does not observe the drain voltage of the first transistor 310. Thus, in a high voltage region of 40 V or higher, the active diode 300 does not suffer from a low breakdown voltage in a control circuit, such as an operational amplifier and a comparator. This structure contributes to achieving an excellent reverse breakdown voltage.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

For example, assumed as the transistors according to Embodiments of the present invention are normally-power-off power transistors in various kinds. In Embodiments, specific terminal names for a Gan-GIT, such as a gate, a source, and a drain of are used. Another normally-power-off transistor, however, may be an insulated gate power transistor such as, for example, a gallium nitride metal insulator semiconductor (GaN-MIS). Other normally-power-off transistors may include the following: A gallium nitride metal semiconductor (GaN-MES) having a gate with the Schottky barrier junction from the contact between a metal and a semiconductor, a MOSFET, a double-diffused MOSFET (DMOS), and a silicon carbide MOSFET (SiC-MOSFET). Such transistors can be used as the transistors for the present invention.

### INDUSTRIAL APPLICABILITY

The present invention can be used as a rectifying circuit for rectifying a lighting circuit voltage ranging between 100 V and 240 V or a high-power-with-a-high-voltage apparatus whose secondary-side voltage at an isolation transformer is 40 V or greater.

What is claimed is:

1. A diode circuit which has an anode terminal and a cathode terminal, said diode circuit comprising:
a first transistor which has a gate terminal, a drain terminal connected to one of the anode terminal and the cathode terminal, and a source terminal connected to the other one of the anode terminal or the cathode terminal; and
a gate voltage generating circuit which (i) is not connected to the cathode terminal but is provided between the gate terminal and the anode terminal, and (ii) delivers a gate voltage to the gate terminal, the gate voltage being adjusted to be equal to a threshold voltage of said first transistor.

2. The diode circuit according to claim 1, further comprising
a second transistor which has a gate terminal, a drain terminal, and a source terminal, the gate terminals of said first transistor and said second transistor being connected each other, either the drain terminals or the source terminals of said first transistor and said second transistor being connected to the anode terminal, and either the drain terminals or the source terminals connected to the anode terminal being connected each other,
wherein said gate voltage generating circuit includes:
a reference voltage source which generates a reference voltage;
a resistor across which a voltage develops, the voltage being for a drain current that runs into said second transistor; and
an operational amplifier which has a positive input terminal that receives the reference voltage, a negative input terminal that receives the voltage generated across said resistor, and an output terminal that is connected to the gate terminals of said first transistor and said second transistor, and
said second transistor is a part of a negative feedback loop of said operational amplifier.
